(19) United States
(12) Patent Application Publication
(10) Pub. No.: US 2019/0372977 A1
(43) Pub. Date: Dec. 5, 2019

(54) SYSTEM AND A METHOD FOR GRANTING AD-HOC ACCESS AND CONTROLLING PRIVILEGES TO PHYSICAL DEVICES

(71) Applicant: Indoor Robotics Ltd., Ramat-Gan (IL)

(72) Inventors: Doron BEN-DAVID, Ramat-Gan (IL); Amit MORAN, Tel-Aviv (IL)

(21) Appl. No.: 16/037,018

(22) Filed: Jul. 17, 2018

Related U.S. Application Data
(63) Continuation-in-part of application No. 15/992,224, filed on May 30, 2018, now abandoned.

(51) Int. Cl. H04L 29/06; H04L 29/08; H04L 12/28

(52) U.S. Cl. CPC H04L 63/0884; H04L 67/125; H04L 63/0807; H04L 12/2818; H04L 63/108

(57) ABSTRACT

The present invention discloses an access management system and a method for controlling access and operations on electronic devices by agents. In some cases, such an agent may be granted permissions to operate the electronic devices upon requesting. Thus, the access management system disclosed in the present invention may be configured to conduct an authorization process, for granting ad-hoc permissions on the electronic devices, to an agent. The access management system may initiate the authorization process by receiving an access-request from an agent. The access management system may conduct an authentication process, and then, upon a successful authentication process the agent may send a control-request for receiving permissions to control and operate at least one electronic device.

### FIELD OF THE INVENTION

The present invention relates to a system and a method for granting a control over a device, and in particular to a method and a system for granting remote access to control a smart device for external authorized personnel

### BACKGROUND OF THE INVENTION

Smart devices, such as virtual assistants, robots, drones, smart cameras etc., which are capable of communicating and sensing are becoming more and more common. The smart devices are widely used, from domestic use through industrial use and even by Law enforcement agencies. Most of the smart devices wirelessly communicate with their user by a plurality of means including the interact.

In some cases, the user would like to provide a temporary access to their smart devices to a third party. Such cases may occur when there is a burglar inside a user's house and the user would like to grant permission to their smart home camera for the police. The permission may be given for either gathering evidence or to help catch the burglar by surprise. Another example occurs when there is a need to physically inspect a house while someone is inside in trouble, such as an elderly person who fell and needs medical attention, but no keys are available. In this case, a remote access might be given to the medical team for a smart home controls to inspect the person in trouble and to either unlock the door through the smart home control.

However, the access to the smart device needs to be temporary and secured without compromising the privacy and the security for the primary user.

### SUMMARY OF THE INVENTION

The present invention discloses an access management system and a method for controlling access and operations on Physical Devices designed to communicate over telecommunications networks. Said controlled Physical Devices are defined herein as SED (“Smart Edge Device” or “smart device”). The term SED is used herein to depict a physical device which can be controlled over telecommunication networks by utilizing the software and computer hardware managed by the SED operating system. SED's can be diverse types of physical devices operated by remote control such as: Virtual assistants, unmanned ground vehicle (UGV), Unmanned aerial vehicle (UAV) also known as drones, unmanned surface vehicle, unmanned underwater vehicle, unmanned spacecraft, balloons, smart cameras, microphones connected to computerized device, electrical devices (such as refrigerators having Internet of things IOT capabilities), electrical devices capable of moving, and the like. In some cases, a SED may be designed to perform single-action operations such as, take pictures, record digital video, record audio, hovering, moving, traveling from one location to another location, and the like. In some cases, the single-action operations may be executed according to operation commands remote controlled by an agent.

In some cases, a SED may be designed to perform multi-action operations such as, cleaning an area by a SED designed to clean areas, relocating from one location to another wherein the SED is capturing digital video frames along the traveling course. Multi-action operation may be such as moving or changing the location from one location to another location, flying to a certain point given by a coordinates of an indoor positioning system, or instruct a drone to fly back to the Ground Control Station (GCS), base station, and the like. In some cases, the multi-action operations may he executed according to operating instructions remote controlled by an agent.

The term “agent” used herein depicts a person identified by the access management system and allowed to request permissions to operate at least one SED. The agent may be required to request ad-hoc permission request for providing operating commands or/and instructions to the SED or the SED's. The request for receiving ad-hoc permission request for providing operating commands or/and instructions to the SED or the SED's may he sent to a SED owner. A SED owner can be a person granted with privileges to grant ad hoc access and permit providing operating commands or/and instructions to the SED to agents. In some cases, a single SED owner may have privileges to grant ad hoc access and permit operations on more than one SED.

The access management system disclosed in the present invention may be configured to conduct an authorization process, for granting ad-hoc permissions on a SED, to an agent. The access management system may initiate the authorization process by receiving an access-request from an agent. The access management system may conduct an authentication process, and then, upon a successful authentication process the agent may send a control-request for receiving permissions to control and operate at least one SED. In some cases, the control-request may comprise specific operating instructions and commands required to the control of the SED. Upon receiving a control-request, the access management system may conduct an authorization process for granting the agent ad-hoc permissions to the sed. Thus, the access management system may send the control-request to a SED owner for approval. The SED owner may conduct an approval process based on the access-request, in an ad hoc fashion. The ad hoc fashion depicts a situation wherein the permission and the access are based on the SED decision, according to the request requirements. In some cases, the SED owner may approve just a portion of the operating instructions and/or commands. In some cases, the SED owner may approve all the operating instructions and/or commands. In some cases, the SED owner may disapprove all the operating instructions and/or commands.

In some cases, the approval may be prepared according to the agents and the SED ID. For example, an approval for access a specific SED, by a specific agent may be prepared in advance and located within the C&C module. In such cases, the agents may be provided with access and control on a SED, without the need to receive an approval from a SED owner.

In some embodiments of the present invention, the access management system can be configured to conduct communication-sessions with the other computerized devices. The communication-sessions can be an interactive information interchange between two or more communicating devices, or computerized devices. The communication-sessions conducted by the access management system, can be with a computerized device operated by the agent, computerized device operated by the SED owner, SED's, and the like. In some cases, the access management system may maintain more than one communication-sessions. In some other cases, the communication-session may be conducted between two or more computerized devices. For example, a communication-session may be conducted between a computerized device operated by an agent and a SED.

In some embodiments of the present invention, the access management system may be configured to provide a communication-session lease. The lease may also have a lease term defining the time the communication-session can last. In such cases, the access management system may generate a token representing the communication-session lease. For example, the access management system may generate a token representing a communication-session lease which allow to conduct a communication-session between a computerized device operated by an agent and a SED. In such an exemplary case, in case the lease term has expired, the communication-session terminates. In some cases, the SED or SED's may comprise a computer-readable medium capable of storing instructions such that executing the instructions by a processing unit causes the SED to perform a method for using the SED.

A SED may be represented in the access management system by a SED ID which can be computer-readable string of characters. Such a SED ID can be a unique name, or string of characters representing the SED ID. The SED may also be configured to receive operating instructions and commands executable by the processing unit of the SED that cause the SED to perform a method for using the SED. For example, the SED may receive from a person operation commands and/or operational instructions which operate and control the SED and, in some cases, components of the SED.

The telecommunications networks utilized to convey communications between the access management system, the SEDs and others may be such as internet, telephone network, ACARS, SCADA, short-range wireless communication-based networks, communication based on personal area network protocols, such as Zigbee, and the like. In some embodiments of the disclosed subject matter the physical devices can be such as robots, drones, cameras, electrical devices communicating over telecommunications networks, I.E., electrical devices with IOT capabilities, and the like. In some embodiments of the present invention, the access management system may be based on a computerized system with a number of software programs operated on at least one computerized device comprising a processing unit, a memory unit and a communication unit, designed to communicate with SED's. The access management system may comprise a token module configured to instruct the computerized device to receive access-request from an agent's device operated by an agent. The token module may be designed to instruct the computerized device to utilize credentials exist in the access-request for conducting an authentication process for an agent operated an agent device. The token module may also be designed to instruct the computerized device to maintain communication-sessions with said computerized device operated by an agent, and generate a token associated with the communication-session, wherein the token defining a communication lease. The token associated with the communication-session may be sent by the access management system to the agent's device.

The access management system may also comprise a SED C&C module designed to instruct the computerized device to receive from the token module a token associated with a communication-session and an access-request from an agent's device operated by an agent. The SED C&C module may also be designed to instruct the computerized device to receive a control-request from an agent, wherein the control-request comprises an agent ID identifying the agent and a SED ID identifying the SED. Upon receiving the control-request, the SED C&C module may send the control-request to a SED owner device operated by a SED owner. In some cases, the SED owner may approve the control-request and send an approval back to the access management system, wherein the approval comprises the operating commands and instructions the agent is entitled to execute on the SED. The SED C&C module may communicate the received operating commands and instructions to the SED, wherein the operating commands and instructions communicated to the SED can be the operating commands and instructions which the agent is entitled to execute, according to the approval.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A discloses a block diagram illustrating an access management system designed to control access and operations on SED's, of agents, according to exemplary embodiments the present invention;

FIG. 1B discloses a block diagram illustrating an access management system designed to control access and operations on SED's, of agents, according to FIG. 1A;

FIG. 2 discloses a block diagram of an access management system designed for controlling access and operations on SED's, according to exemplary embodiments of the present invention;

FIG. 3A shows a flowchart illustrating a method for providing a control of a SED to an agent by an access management system, according to exemplary embodiments the present invention;

FIG. 3B shows a flowchart illustrating a method operable by the access management system for controlling communications between an agent and SED, according to exemplary embodiments of the present invention;

FIG. 4 shows a flowchart illustrating a method for requesting and receiving a control of a SED by an agent, according to exemplary embodiments of the present invention, and;

FIG. 5 shows a process of communicating an operating command from an agent to a SED, according to exemplary embodiments of the present invention;

FIG. 6 discloses a method for detecting a SED by an agent via detecting signals sent by the SED, according to exemplary embodiments of the present invention, and;

FIG. 7 discloses a configuration of the access management system incorporating an NFC device utilized to identify the SED, according to exemplary embodiments of the present invention.

### DETAILED DESCRIPTION OF THE INVENTION

The present invention discloses an access management system and a method for controlling access and operations on a SED or SED's by agents. In some cases, such an agent may be granted permissions to operate the SED or the SED's upon requesting. Thus, the agent may be required to request ad hoc permissions for performing commands or/and operations on the SED or the SED's.

The SED's to which the present invention refers is designed to comprise a computer hardware, or physical parts or components of a computer hardware. The computer hardware can comprise a central processing unit, computer data storage, network interface controller, and motherboard. In some cases, the computer hardware may comprise additional components such as monitor, keyboard, graphic card, sound card, and the like. In some cases, the SED may also comprise system software, denoted as SED operating system, which manages the computer hardware and software resources, and provides common services for computer programs. Such a SED can be controlled over telecommunication networks by utilizing the software and computer hardware managed by the SED operating system.

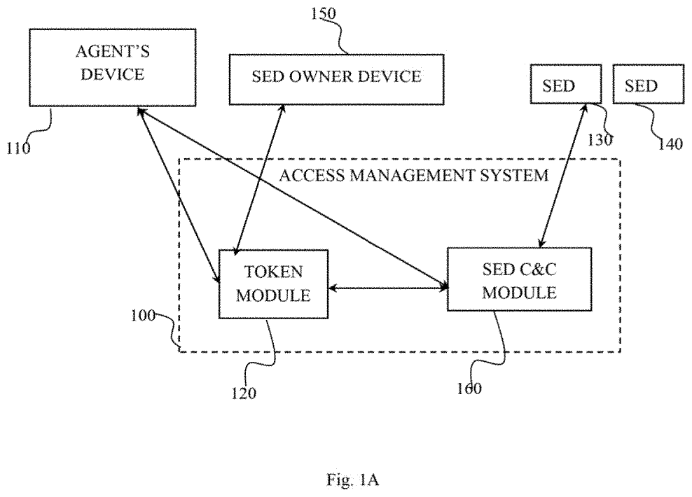

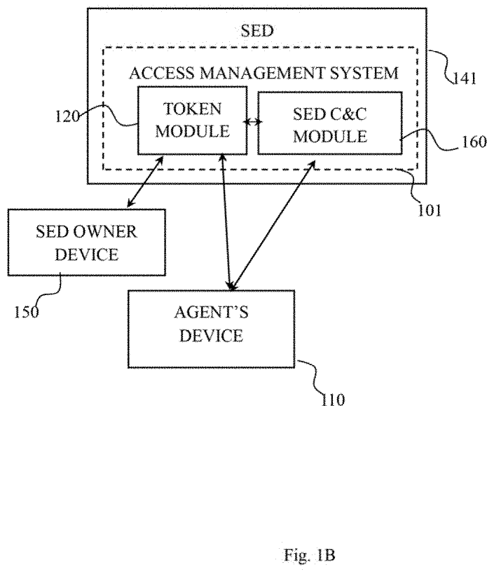

FIG. 1A discloses a block diagram illustrating an access management system designed to control access and operations on SED's, of agents, according to exemplary embodiments the present invention. FIG. 1A shows an access management system 100 configured to manage agents by SED owners. A few examples for such cases are: (1) In cases wherein, the SED is a drone equipped with a camera designed to hover inside and/or outside a building, or a three-dimensional structure. The SED may be configured to shoot digital video at a building and the three-dimensional environment surrounding the building. In such cases, an agent may require permissions to remotely operate the camera located at the SED. In some cases, the agent may be a guard or a policeman. (2) An agent which may be a technician requires access a security system for conducting a maintenance and/or hardware upgrade while the owner is away.

The access management system 100 may be configured to receive access-requests from an agent's device 110, for communicating with the access management system 100. The access-request can be sent by an agent operating agent's device to the access management system 100 for receiving permissions to communicate with the access management system 100. The access management system 100 may also be configured to receive control-requests from the agent's device 110. The control-requests can be sent by an agent to the access management system 100 for receiving an approval to remotely connect and operate the SED.

In some cases, such an approval may be received from a SED owner operating a SED owner device such as SED owner device 150. In some cases, the permissions to remotely control and operate the SED may allow some specific and predefined operating instructions and commands. The operating instructions and commands may be such as, fly and navigate drone to a certain direction, utilize a camera in a SED, navigate a robot to a certain direction, illuminate to a certain physical point by light, changing the position of a camera, receiving digital data from a SED, via telecommunications network, turning on a light in the room, and the like.

The access management system 100 comprises a token module 120 configured to manage and control authentication and authorization processes in the access management system 100, as explained below. The access management system 100 also comprises SED command and control module 160, denoted herein as SED C&C module 160 which can be configured to manage the communication-session between the agent's device 110 and a SED 130, and/or SED 140, as explained below. In some cases, the token module 120 and the SED C&C module 160 may be two separate modules of computer-programs operated on a computerized device. Such a computerized device may comprise memory for storing data accessible by the two-separate computer-program modules, token module 120 and SED C&C module 160.

The computerized devices operating the token module 120 and SED C&C module 160 can be computerized devices capable of executing programed applications such as a computerized server, a personal computer, a virtual server, a computerized mobile device, and the like. In some embodiments of the present invention, the token module 120 may be operated on one computerized device and the SED C&C module 160 may be operated on another computerized device. In such cases, the two computerized devices may be physically separated from each other. For example, SED C&C module 160 may be operated on a computerized server and the token module 120 may be operated on a different computerized server. In such cases, the SED C&C module 160 and the token module 120 may be configured to communicate via telecommunications networks. For example, the token module 120 operable on one physical server may be configured to communicate with the SED C&C module 160 operable on another physical server via TCP/IP protocol. In some embodiments of the present invention, the SED C&C module 160 may be operated on the SED. In such cases, the access management system 100 may be required to maintain a communication-session with the SED (such as SED 130 or SED 140) for communicating with the SED C&C module 160.

The token module 120 can be configured to conduct authentication processes with agents sending access-requests to the access management system 100. In some cases, such access-requests may comprise credentials belonging to the agent and which can be utilized at the authentication process. In such cases, the access management system 100 may receive the credentials and then direct the credentials to a token module 120 The token module 120 may receive the credentials at the access-request and validate the credentials. In some cases, the authentication process can utilize the credentials belonging to the agent. Such a process may be also known as user authentication. In some cases, the authentication process can utilize the credentials belonging to the computerized device operated by the agent. Such a process may be also known as device authentication. In some cases, the computerized device operated by the agent may also be registered in the access management system 100. In some cases, the device authentication may be provided by utilizing Radio-frequency identification, also known as RFID. In such cases, an agent may be allowed to utilize an RFID device associated with the agent's device 110 for identifying an agent's device ID as explained below. In some other cases, the device authentication may be provided by utilizing Near-field communication, also known as NFC. In such cases, an agent may be allowed to utilize an NFC device associated with the agent's device 110 for identifying an agent's device ID as explained below. For example, an agent may position the agent's device 110 in a close proximity to a door, or to any other place which manifests abilities to detect and recognize NFC. The NFC recognition may identify the agent's device ID of the agent's device 110 and thereby the device authentication process can imitate. In some other cases, the authentication process can utilize both, the device credentials, and the agent credentials.

In some embodiments of the present invention, the control-request may also comprise an agent ID which can be utilized in the authentication process. In some cases, the agent ID may be such as a computer-readable file with agent details and a time stamp, digital certificate, an encryption key, an integer value, a string of computer-readable characters such as a password, personal identification number, and the like. In some cases, agent ID may be utilized to verify whether the agent ID exists in the access management system 100.

The control-request received by the access management system 100 may be required to be approved by a SED owner after the authentication process has completed successfully. In such cases, a control-request received by the access management system 100 may be sent further by the token module 120 to the SED or SED's owner connected by SED owner device 150. The access management system 100 can also be configured to manage the control-requests. The control-request may initiate the authorization process for the agent. In some cases, the control-request may comprise an agent ID which can be utilized in the authorization process of the agent. In some cases, the agent ID may be such as a computer-readable file with agent details and a time stamp, digital certificate, an encryption key, an integer value, a string of computer-readable characters, RFID, NFC, and the like.

The authorization process can he used to determine which operating instructions and commands a certain agent can perform on which SED's. In some cases, the control-request may be required to be approved by a SED owner after the authentication process has completed successfully. In such cases, the control-request received by the access management system 100 may be sent further to the SED or SED's owner which may operate computerized devices, such as SED owner device 150. In some cases, the SED owner devices 150 may comprise a SED owner devices ID. In such cases, the access management system may send the control-request according to the SED owner device ID. The control-request sent to the SED owner devices 150 may comprise details such as an agent ID, agent's device ID, a SED ID, and the like. In some cases, the SED ID can be computer-readable digital string of characters. Such a SED ID can be a unique name, or string of characters representing the SED ID.

The SED owner may utilize the SED owner device 150 to review the details of the control-request and to approve or disapprove thereof. Then, in case the control-request approved, the approval may be sent back to the access management system 100. For example, a control-request to control SED 130 and SED 140, may be sent by an agent via the agent's device 110 to the access management system 100. Then, the control-request may be received by the access management system 100 and sent further to the SED owner operating the SED owner device 150, for approval. In some cases, upon receiving back the approval from the SED owner device 150, the access management system 100 may send the control-request and the approval thereof to the SED C&C module 160. The SED C&C 160 may receive the control-request and the approval thereof, and a permit the agent to operate the SED which the agent is entitled to execute according to the approval. In some cases, the control request may also comprise the specific types of the operating command and or SED perform. In some cases, the control-request may comprise the operating commands and/or the operating instructions the agent requests to be executed.

The control-request can comprise the specific operating instructions and commands which the SED owner permits to the agent in a specific communication session and the amount of time defined for the communication-session between the agent's device 110 and the SED's 130 and/or 140. In some cases, upon arrival of the approval from the SED owner, the token module 120 may define a communication-session and a lease. The lease may also have a lease term defining the time the communication-session can last. In such cases, the token module 120 may generate a token representing the communication-session lease. In some cases, the communication-session may be defined as a remote connection between the agent's device 110 and the SED C&C module 160.

In some embodiments of the present invention, the agent may receive the token defining the lease and the lease term. The communication-session can be defined as an interactive information interchange between two devices, such as between the agent's device 110 and SED's 130 or/and 140. In some cases, the communication-session may be a connection between the agent's device 110 and the SED's 130 or/and 140. Such a connection may be via SED C&C module 160. In some other cases, the communication-session may be via utilizing web services such that the operating instructions and commands may be send via internet services. For example, operating instructions and commands may be sent from the agent's device 110 to the SED C&C module 160 by utilizing SOAP or REST methods. In such cases, the SED C&C module 160 may communicate the operating instructions and commands to the SED's 130 or/and 140. In some cases, communicate the operating instructions and commands to the SED's 130 or/and 140 may be over telecommunications networks, such as LAN, WAN, TCP/IP based communication methods, and the like. In some other cases the SED C&C module 160 may instruct the SED by executing the command directly on the SED. For example, in case the SED C&C module 160 is installed on SED 140 (or SED 150), the SED C&C module 160 may allow executing the operating instructions and commands by utilizing a software interface operated by the access management system 100.

In some embodiments of the present invention, the lease term defined by the access management system 100 can be associated with the communication session. In such cases, once the lease is defined for the agent's device 110, a communication-session associated with the token can be established. For example, a communication-session between an agent's device 110 associated with a token can be established with the access management system 100, for a certain period defined by the lease term. The lease for the communication-session may be provided upon a successful authentication process and/or upon an approval process conducted by a SED owner. In some cases, the token which defines the lease and the lease term may be stored in the agent's device 110. In some other cases, said token may be stored in the token module 170.

The lease term defines a communication-session which can last a limited time period, I.E., 5 minutes, 20 minutes, 1500 minutes, and the like. In such exemplary case, once the predefined time period has elapsed, the communication-session may be terminated by the SED C&C module 160.

In some embodiments of the present invention, the lease term may be associated with the token. In such cases, the agent connected with a first communication-session may be able to disconnect the first communication-session between the agent's device 110 and the SED C&C module 160, or in some cases, the SED and then, reconnect the agent's device 110 to the SED C&C module 160 or in some cases, to the SED, without undergoing an authorization process. Thus, in case the lease term associated with the token has not expired, another communication-session can be established between the agent's device 110 and the SED C&C module 160, or'the SED. In such cases, the agent utilizing the second communication-session may have the same authorizations as provided with the first communication-session. For example, an agent operating an agent's device 110 may control the SED 130. The agent's device 110 may use a first communication-session to the SED C&C module 160, wherein the lease term defined in the token has not terminated. In such exemplary case, the agent may be able to disconnect the first communication-session, and then in case the lease term has not expired, the agent may be able to establish a second communication-session between the agent's device 110 and the SED C&C module 160 with the same lease term and without undergoing an authorization process.

In some embodiments of the present invention, the SED C&C module 160 may control the operating instructions and commands sent from the agent's device 110, according to the approval of the communication-session. For example, an agent operating agent's device 110 controlling a SED may send a command to move the SED from one location to another. The agent may be able to send the SED, data indicating the other location and a command which instructs the SED to move to said other location. In such an exemplary case, the SED C&C module 160 may be able to receive the command, verify if the command to move the SED can be allowed in this communication-session, according to the approval. In such a case, if the command to move the SED to the other location can be allowed according the approval, the SED C&C module 160 may send the command to the SED by utilizing a communication-session established between the SED C&C module 160 and the SED. In some cases, the token module 120 may be configured to require another authentication process in case the communication-session has terminated. For example, in case the communication-session between the agent's device 110 and the SED C&C module 160 has terminated and the agent may request reconnect to the SED, the token module 120 may require conducting an authentication process.

In some cases, the SED C&C module 160 may require conducting an approval process before establishing the communication-session with the agent's device 110. In such cases, the token may be utilized to validate the lease term of the communication-session. For example, the SED C&C module 160 may validate that a communication-session is utilized according the lease term as defined in the token, in every periodically time interval. In some cases, the token defining the lease can comprise details such as, the agent identity, time step associated with the token issued time, a digital signature associated with the agent or with a certificate, a password or a secret held by the agent's device, and the like. In some cases, the token may be such as, a computer-readable file with agent's details and a time stamp, digital certificate, an encryption key, and the like.

In some embodiments of the present invention, tokens issued by the token module 120 may be stored and managed in said token module 120. In such cases, the SED C&C module 160 may validate the token by connecting to the token module 120. The SED C&C module 160 may validate the token according to some details as defined in the token. Such details can be, lease term, time stamp, device ID, details in a digital certificate information, session encryption key, session key, computer-readable file, and the like. For example, the SED C&C module 160 may connect to the token module 120 and validate the token associated with a communication-session between the agent's device 110 and a SED (for example, SED 130, or SED 140) by reading the token information from the token stored and managed by the token module 120. The SED C&C module 160 may execute a process which connects with the token module 120 and verify the details in the token information. In some cases, upon validating the token in the token module 120, the SED C&C module 160 may allow agent's device 110 to operate the SED. The access given by the SED C&C module 160 may be limited in accordance with the user authorization.

In some embodiments of the present invention, the SED C&C module 160 may be utilized as a proxy for the communication between the agent's device 110 and the SED, or the SED's which the agent is authorized to control. In such cases, the agent's device 110 may establish a communication-session with the SED C&C module 160, and the SED C&C module 160 may establish a communication-session with the SED (for example, SED 130, or SED 140), in such a case, the agent may send operating instructions and/or commands addressed to SED 130, or SED 140 from the agent's device 110 to the SED C&C module 160. The SED C&C module 160 may also be configured to review the sent operating instructions and/or commands, approve thereof according to the approval and the then forward the approved operating instructions and/or commands to the to the SED (for example SED 130, or SED 140). In some cases, the SED C&C module 160 may associate both communication-sessions, the communication-session with the SED, and the communication-session with the agent's device 110, with the same token.

In some embodiments of the present invention, the SED C&C module 160 may be configured with access rules and command list which can define the operations of the agent on the SED. The access rules and the command list can comprise rules and business logics for operating the SED. In some cases, the access rules and command list may be associated with an agent. In some other cases, the access rules and command list may be associated with an agent's device such as agent's device 110. For example, the access rules can define that certain agents, identified by agent ID may not be able to control a certain SED or send commands to a certain SED, in a specific time of the day. In some cases, the access rules and the command list may define that specific command may not be allowed by a certain portion of agents eligible to connect to the access management system 100. For example, the access rules and the command list may define that a certain agent may not operate the camera located in a SED. In such cases, the SED C&C module 160 may be configured to receive the control commands sent, by the agent, via the communication-session established with the agent's device 110 and remove away the unauthorized commands, according to the access rules and the command list. The SED C&C module 160 may also be configured to send the authorized commands to the SED, via the communication-session established with the SED.

For example, an agent may send a access-request for establishing a communication-session between the agent's device 110 and the SED C&C module 160, to control a SED. The SED C&C module 160 may establish a corresponding communication-session with the SED, in order to send the commands received from the agent's device 110. In such an exemplary case, the agent may be authorized to operate a video camera located on the SED. In such a case, the agent may operate the SED via commands sent to the SED C&C module 160. The SED C&C module 160 may receive the commands via the communication-session established with the agent's device 110, review the commands and verify that the agent is entitled to send the reviewed commands, in accordance with the agent ID (and/or the lease term defined in the token). Then, the SED C&C module 160 may send the commands to the SED via the communication-session between the SED C&C module 160 and the SED. In such cases, wherein the agent sends commands to operate the camera located on the SED, the SED C&C module 160 may receive the commands addressed to SED, omit the commands related to the video camera operation and send the authorized commands only. In such an exemplary case, the commands for operating the video camera may not be sent to the SED.

The access management system 100 may be configured to associate one token with the following: An agent, an agents' device, a communication-session between the SED C&C module 160 and the SED, and approval, and a control-request, a communication-session between the agent's device and the SEC C&C module 160.

FIG. 1B discloses a block diagram illustrating an access management system designed to control access and operations on SED's, of agents, according to FIG. 1A. FIG. 1B shows an access management system 101 located at the SED 141 and operated thereon. Access management system 101 configured to manage agents by SED owners as aforementioned. In some cases, the SED 141 may be configured to operate a computer operating system. For example, a SED comprising a SED operating system can be configured to operate the access management system.

The access management system 101 may be configured to receive access-requests from an agent's device 110. The access management system 101 comprises a token module 120 configured to manage and control authentication and authorization processes in the access management system 101, as aforementioned. The access management system 101 also comprises SED command and control module 160, denoted herein as SED C&C module 160 which can be configured to manage the communication-session between the agent's device 110 and SED 141, as aforementioned.

The token module 120 can be configured to conduct authentication processes with agents sending access-requests to the access management system 101. In some cases, such access-requests may comprise credentials of the agents which can be utilized at the authentication process. In such cases, the access management system 101 may receive the credentials and then direct the credentials to a token module 120. The token module 120 may receive the credentials at the access-request and validate the credentials. In some cases, the authentication process can utilize the credentials belonging to the agent. Such a process may be also known as user authentication. In some cases, the authentication process can utilize the credentials belonging to the computerized device operated by the agent. Such a process may be also known as device authentication.

The SED owner may utilize the SED owner device 150 to review the details of the control-request and to approve or disapprove thereof. Then, in case the control-request approved, the approval may be sent back to the access management system 101. Then, the control-request may be received by the access management system 101 and sent further to the SED owner operating the SED owner device 150, for approval.

In some embodiments of the present invention, the access management system 101 may be configured to support cases, wherein the access-request is sent from the agent's device 150 to the SED 141. Then, the token module 120 may conduct an authentication process, and upon a successful authentication process, the agent may receive a token and send back a control-request. In such cases, the control-request may be sent to the SED owner device 110 and upon receiving an approval from the SED owner, the SED 141 may accept operating commands and instructions sent from agent's device 150. In such cases, the operating commands and instructions which be accepted by the. SED 141 may be, the operating commands and instructions which the agent is entitled to execute.

In some cases, upon approving the control-request, the SED owner may utilize the SED owner device 110 to generate a session key. The session key may be an encryption key utilized to encrypt and decrypt messages received and sent via the communication-session with the SED. For example, upon sending, an approval to the SED and/or to the access management system 101, the SED owner may generate a session key, which can be associated with the token. The session key may be utilized by the SED C&C module 160 and by the agent's device 110 to encrypt and decrypt the content of the communication-session.

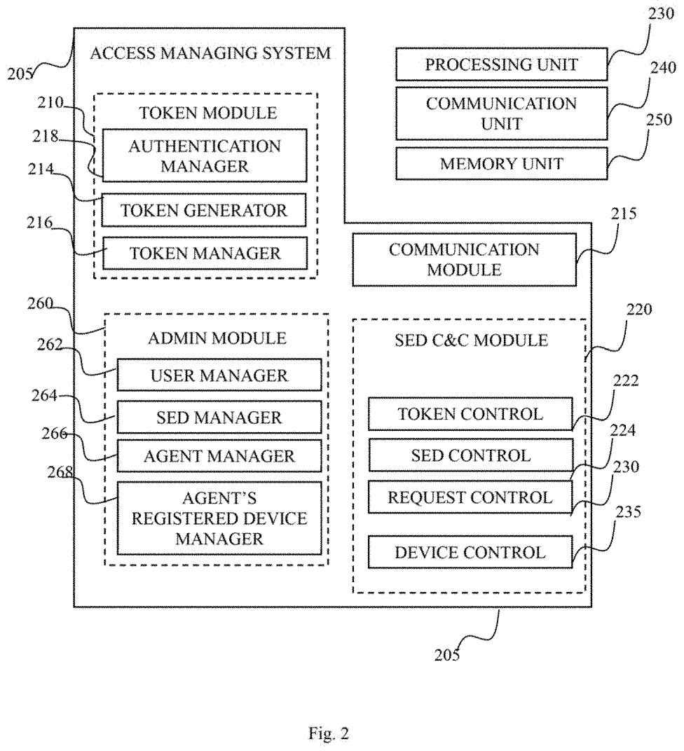

FIG. 2 discloses a block diagram of an access management system designed for controlling access and operations on SED's, according to exemplary embodiments of the present invention. FIG. 2 shows an access management system 205 designed as a computer software application programmed and configured to control access and operations on SED's. In some cases, the access management system may he operated on a computerized device comprising a computer hardware, or physical parts or components of a computer hardware. The computerized device may also comprise a software designed to operate the computer hardware.

The access management system 205 comprises a token module 210 designed to manage, store, control, generate, and send the tokens as aforementioned. The token module 210 comprises an authentication manager 218 designed to conduct the authentication processes of agents and the devices operated by said agents. The authentication manager 218 is configured to receive the credentials from the device operated by the agent, validate the identity of the agent or/and the identity of the device. In some cases, the credentials validated by the authentication manager 218 may comprise the agent ID. In some cases, the credentials provided during the authentication process may also comprise a unique secret such as a password, a private key, a biometric credential, an encryption key, and the like. In some embodiments of the present invention, a control-request may be handle before approving the issue of a token.

The token module 210 also comprises a token generator 214 designed to define a lease and then generate the tokens associated with the communication-session. Such a communication-session can be with an agent's device, and/or a SED. The token module 210 may be configured to associate the token with said communication-session, a lease term, an agent's device ID, an agent an access-request, an approval associated with said access-request, and a SED. In some cases, the token generator 214 may be able to generate a computer-readable files which can comprise the information required for maintaining such a communication-session. Such an information may comprise inter alia the agent name, communication-session identifier, a time stamp indicating the token issued time, lease term, agent ID, agent's device, and the like. For example, in some cases, the token generator 214 can operate a certificate authority also known as a CA designed to issue digital certificates. In such an exemplary case the CA may be configured to add the information required to maintain the communication-session with the digital certificate. In such cases, the communication-session may be maintained according to the information of the digital certificate. In some other cases, the token can be a computer-readable file which can be utilized by the access management system 205.

The token module 210 also comprises a token manager 216 designed to store and manage the tokens generated by the token generator 214. The token manager 216 may be configured to store the generated tokens and manage thereof according to the token information. In some cases, the token manager 216 may utilize a computer-readable medium such as memory unit 250 for storing the tokens. The token manager 216 may also be configured to maintain the token according to: The communication-sessions with which the tokens are associated, the lease period associated with the token, the agent ID, and the like. In some cases, the token manager 216 may erase tokens which may not be valid or used for any communication-session, or the lease term has expired. In some cases, the token manager 216 may also be configured to present or in some cases to provide tokens to other computerized process operated in the access management system 205. For example, in case an agent requires to reconnect and utilized an existing token with a lease term associated with the token, as aforementioned, the token manager may be able to present the token to any external computerized process which requires to validate the token.

In some embodiments of the present invention, the token 210 may be designed as an independent computer software module operable on a processing unit such as processing unit 230. The processing unit 230 can comprise at least one processor designed to carry out the instructions of computer programs. The token 210 may also he configured to utilize a memory unit 250 which may he a computer-readable medium designed to gather and store information for use of computer programs. For example, the token manager 216 may utilize the memory unit 250 to store tokens associated, with communication-sessions. The token module 210 may also be configured to communicate with some external modules, managed and operated by the access management system 205 via communication unit 240. For example, the SED C&C module 220 and the token manager 216 can utilize the communication unit 240 to exchange data. The communication unit 240 may also be utilized to convey the data exchanged between the access management system 205 and the token module 210, or the agent's device 210 and SED's as aforementioned. For example, in case a SED owner sends an approval to a control-request, the approval and the control-request may be conveyed via the communication unit 240.

In some cases, wherein the token module 210 and the SED C&C module 220 are operated and managed in one computerized device, the communication between the SED C&C module 220 and the token module 210 be managed by an internal communication module such as communication module 215. The communication module 215 may be a computer software designed to convey the data exchanged among the modules managed by the access management system 205. The communication module 215 may also utilize the processing unit 230, and in some cases, utilize the memory unit 250 for the internal computerized operations. For example, in case the token module 210 conveys data to the SED C&C module 220 by the communication module 215, the communication module 215 may utilize the memory unit 250 for temporarily storing the conveyed data. The communication unit 215 may also be utilized to manage the communication between the communication unit 240 and the token module 210, the admin module 260 as explained below, and the SED C&C module 220. For example, in case a SED owner sends an approval to a received control-request, the approval and or the control-request may be sent via the communication unit 240 to the communication module 215 and then to the SED C&C module 220.

The access management system 205 comprises an admin module 260 designed to manage inter alia the agent's devices, the SED's, the SED's owners the and agents. The admin module 260 comprises a user manager 262 designed to store and manage the SED owners and the SED's associated with the SED owners. In some cases, a SED owner stored and managed by the user manager 262 may be associated with a SED owner identifier and SEM which the SED owner has the privileges to grant access and enable performing operations. In some cases, the sed owner devices associated with SED owners may also be stored and managed by the user manager 262. The user manager 262 may be able maintaining a database for storing the SED owners' names or ID's, and managing the data associated with the SED owners. In some cases, the user manager 262 may utilize the memory unit 250 for storing the data. In some other cases, the user manager 262 may utilize an alternative memory unit for storing and managing said data.

The admin module 260 also comprises a SED manager 264 designed to store and manage the SEDs' ID's and the SED owner thereof. The SED manager 264 may be able maintain a database for storing the ID's of the SED's, the SED owners' names or ID's, and managing the data associating SED's ID's with the SED owners. In some cases, the SED manager 264 may also utilize the memory unit 250 for storing data. In some other cases, the SED manager 264 may utilize an alternative memory unit for storing and managing the data. The admin module 260 also comprises an agent manager 266 designed to register and manage the agents utilizing the access management system 205. The agent manager 266 may be able maintain a database for storing the agents.

In some cases, the agent manager 266 may store historical data of the agent connections and the devices utilized by the agents to connect to the access management system 205. In some cases, the historical data may comprise the SED to which the agents connected in the past. In some cases, the agent manager may comprise some business logics which can be utilized in the operation of the access management system 205. For example, the agent manager 266 may be able to operate a rule which allows to establish a communication session between an agent and a SED, only in case, the agent has already been connected to the SED in the past.

The admin module 260 also comprises an agent's device manager 268 designed to register and manage the agent's devices utilized by the agent. The agent's device may be represented by an agent's device ID, denoted herein as agent's Device ID.

The agent device manager 268 may be able maintain a database for storing the agent's device manager 268 according to the agent's device ID's thereof. In some cases, the agent's device manager 268 may also utilize the memory unit 250 for storing data. The data may comprise details such as a description of the agent's devices, the agent's device ID, and the like. In some other cases, the agent's device manager 268 may utilize an alternative memory unit for storing and managing the data. In some cases, the agent's device manager 268 may be configured to verify if an agent's device is entitled to establish a communication-session with the access management system 205. In some the registered device manager 268 may receive an agent's device identifier to verify if the agent's device is entitled to connect to the access management system 205.

The access management system 205 comprises a SED C&C module 220 designed to manage the access-requests, the control-request and the communicans with the SED's. The SED C&C module 220 comprises a token control 222 designed to validate the tokens of given communication-sessions. In some cases, the validation may be by communicating with the token manager 216 and validate the token and the lease term associated with said token. In some cases, the token control 222 may be communicating with the agent's device for validating the token and the lease term associated with said token. The token control 222 may utilize the communication module 215 and in some cases the communication unit 240 for validating the tokens. For example, the token control 222 may utilize the communication module 215 to validate a token managed by the token manager 216. In some cases, the communication unit 240 may also be utilized to validate a token stored and managed by an agent's device.

The SED C&C module 220 also comprises a SED control 224 designed to carry out the connections with the SED's. The SED control 224 may be configured to establish a communication-session with the SED's and send operation command and operational instructions to the SED's. The SED control 224 may receive the commands via the communication-session established with the device control as explained below, review the commands and verify that the agent is entitled to send the commands, in accordance with the agent ID and/or the lease term defined in the token. Then, the SED control 224 may send the commands to the SED via the communication-session between the SED control 224 and the SED. In some cases, the SED control 224 may communicate with the token control 222 for validating the token and reviewing the lease term. The SED control 224 may also be able to communicate with the request control 230 as explained below.

The SED C&C module 220 comprises a request control 230 designed to hold and manage the requests received from agents and the corresponding approvals received from the SED owners. In some cases, the request control 230 may be accessed by the SED control 224 for verify the authorizations which apply to the communication-sessions. For example, in case the agent sends commands for operating the SED, the request control 230 may receive the commands addressed to SED, verify the approval associated with the communication-session and in cases needed, omit the unauthorized commands according to the approval, and send the authorized commands only.

The SED C&C module 220 also comprises a device control 235 designed to carry out the connections with the agent's devices. The device control 235 may be configured to establish a communication-session with the agent's devices and receive the operation command and operational instructions for the SED's. The device control 235 may receive the commands via the communication-session established with the device control 235, review the operation command and operational instructions and send to the SED control 224. Then, the SED control 224 may send the commands to the SED via the communication-session between the SED control 224 and the SED. In some cases, the SED control 224 may communicate with the token control 222 for validating the token and reviewing the lease term. The SED control 224 may also be able to communicate with the request control 230 as aforementioned.

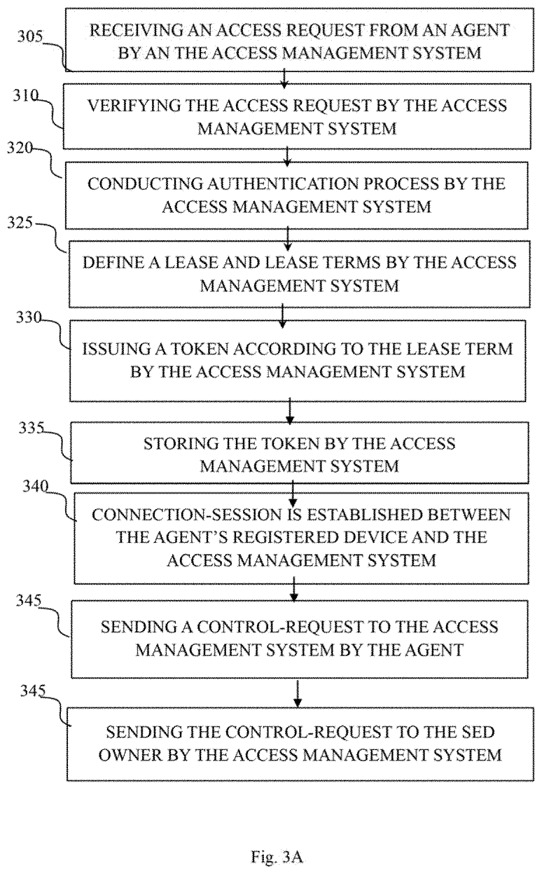

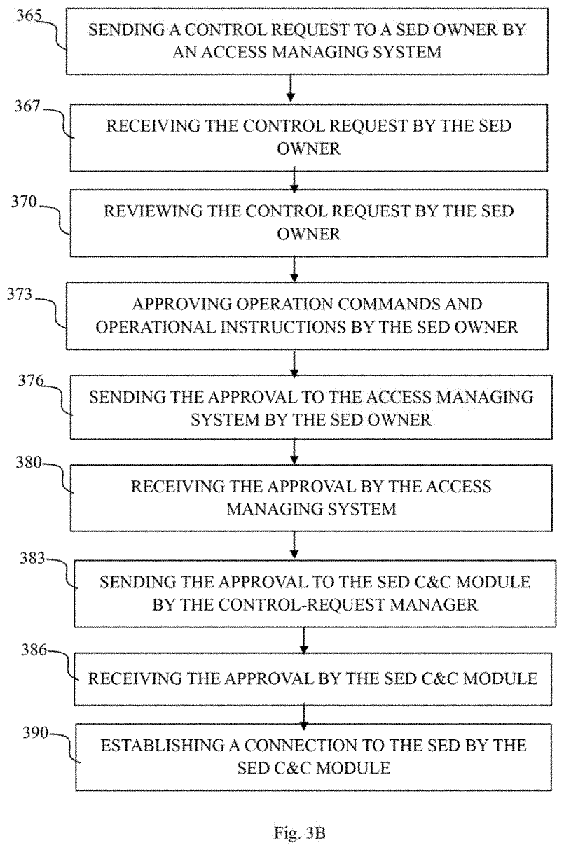

FIG. 3A shows a flowchart illustrating a method for providing a control of a SED to an agent by an access management system, according to exemplary embodiments the present invention. At step 305 an access management system receives an access-request. The access-request may be received from an agent operating an agent's device configured to send access-requests to access management systems. In some cases, the access-request may comprise access information. The access information may comprise details such as: an agent identifier a device name, connection details, for example the IP address of the device, and the like. The access information may also comprise the location of the agent's device, the agent's device ID of the agent's device used in the registration process, and the like.

At step 310 the access management system receives and verifies the received access-request. The access management system may verify that the agent's device is entitled to communicate with the access management system, and/or operating a SED. For example, an admin module of the access management system may utilize the agent's device manager to verify that a registration of the agent's device appears as a registered agent's device in the access management system, and the agent's device manager is entitled to establish a communication-session with the access management system. At step 320 the access management system may conduct an authentication process according to the information of the received access-request. In some cases, the authentication process may utilize the agent credentials existing in the access-request information.

In some cases, the agent's device ID of the agent's device may be required in the authentication process. In some cases, the access management system may require additional credentials at the course of the authentication process. Such an additional credentials may be a password, one-time-password, digital certificate and the like. For example, the access management system may receive an access-request sent by an agent from an agent's device and verify if the agent's device ID appears in the access management system. The access management system may send back to the agent's device a request to the agent to provide a password. The agent may provide the password to the agent's device and then, the agent's device may send the password back to the access management system. The access management system may validate the password, and in case the password is valid and correct, the access-request sent from the agent's device can be approved by the access management system.

At step 325 the access management system may define a lease for the communication-session, the lease definition may comprise information about the agent's device and the agent utilized thereof. In some case, the lease definition may be associated with information about the communication-session. The information can be such as, the agent's device location, the Internet Protocol address (also known as IP address) of the agent's device ID, and the like. The lease definition may also comprise a lease, term defining the period of time the communication-session can last. At step 330 the access management system may issue a token according to the lease definition and the lease term defined at step 325. In some cases, the token may comprise some information required for establishing the communication-session, according to the given lease.

The token information may also comprise a time stamp indicating the time the token was issued. In some cases, the token information may also have an expiration date. For example, a token may have an expiration date, defining the ending of the fixed period for in which the token is valid. Such a token may not be valid for use in case the token is expired. The token information may also comprise information about the token type. For example, a token type can be a token associated with the communication-session. In such cases, the token can be used to present a lease and lease term associated with the communication-session. For example, the communication-session may be terminated in case the communication-session time has exceeded the time defined in by the lease term. In some cases, the token type can be a token which presents a lease associated with the token. For example, a lease associated with the token can be utilized in case an agent disconnects a first communication-session associated with a token, and then reconnects to the access management system. The agent may be able to reconnect to the access management system and utilize the token which has been utilized with the first communication-session, in case the lease term appearing in the token information are still valid.

In some cases, the token type can be a token which presents a lease associated with the connection type between the agent and the access management system. For example, an agent may be able to communicate with the access management system in case the connection between the agent's device and the access management system and/or the SED is over wireless networks.

In some cases, the token type can be a token which presents a lease associated with maximum or minimum distance between the agent and the access management system. For example, an agent may be able to communicate with the access management system. In case the required distance between the agent's device is below a specific distance from the access management system and/or the SED. At step 335 the token may be stored. In some cases, the token may be stored by the token manager. The token manager can store the token in a dedicated storage medium and manage the token according to the token information. At step 340 the access management system can establish a communication-session with the agent's device. The communication-session may be utilized by the agent's device to receive and convey messages, operation commands, operational instructions, and the like, addressed to the SED. In some embodiments of the present invention, the connection between the agent's device may be directed to the SED. For example, in case the C&C SED module is located at the SED and operated thereon. Thus, in some cases, the SED may be configured to manage two communication-sessions. The communication-sessions may be one communication-session between the SED and the access management system, and additional communication-session between the SED and the agent's device. In some cases, the SED may utilize only one communication-session between the SED and the agent's device. For example, in case the token is stored at the agent's device, and the SED C&C module is located at the SED and operated thereon. In such cases, the SED C&C module may be able to validate the token at the agent's device via the communication-session between the SED and the agent's device.

At step 345 the agent may utilize the, agent's device to send a control-request to the access management system via the newly established communication-session. At step 350 the control-request may be sent by the access management system to the SED owner as explained below.

FIG. 3B shows a flowchart illustrating a method operable by the access management system for controlling communications between an agent an SED, according to exemplary embodiments of the present invention. Step 365 a control-request received by the access management system may be sent from the access management system to a SED owner. The control-request may follow a process of establishing a communication-session between the access management system and the agent's device, as aforementioned. In some cases, the control-request may be received and managed by a request control. At step 367 the SED owner may receive the control-request. In some cases, the SED owner may utilize a software application operated on the SED owner device. The software application utilized by the SED owner may be configured to present and manage such control-requests. In step 370 the SED owner may review the control-request. In some cases, the SED owner may be able to receive information associated with the control-request received from the access management system. Such information may comprise the agent's device ID, the current location of the agent, the location of the SED, the number of SED's and the SED ID's thereof which the agent may be allowed to control and operate, and the like.

At step 373 the SED owner may conduct an approval process of the control-request. The SED owner may be able to approve or disapprove the operation commands and the operational instructions in the control-request. For example, the SED owner may approve playing a sound by the SED and disapprove illuminating a light from the SED. At step 376 the SED owner may send an approval comprising the approved operating instructions and commands to the access management system In some cases, the request control may receive and manage the approvals sent by the SED owner. In some embodiments of the resent invention, a session key generated by the SED owner device may be associated with approval. The session key may be sent to the agent's device. The session key may also be stored in the token module of the access management system. In some cases, the session key may be utilized to encrypt and decrypt the payload of the messaging between the agent's device and the access management system. At step 380 the access management system may receive the approval sent by the SED owner. In some cases, the access management system may verify the identity of the SED owner or the SED owner device. Such an identity verification can be according to credentials sent by the SED owner. SED owner device ID sent by the sed owner device, and the like.

At step 383 the approval may be sent to the SED C&C module by the request control. At step 386 the approval sent by the request control may be received by the SED C&C module. At step 390, the SED C&C module may establish a communication-session between the SED C&C module and the SED, or in some eases the SEDs.

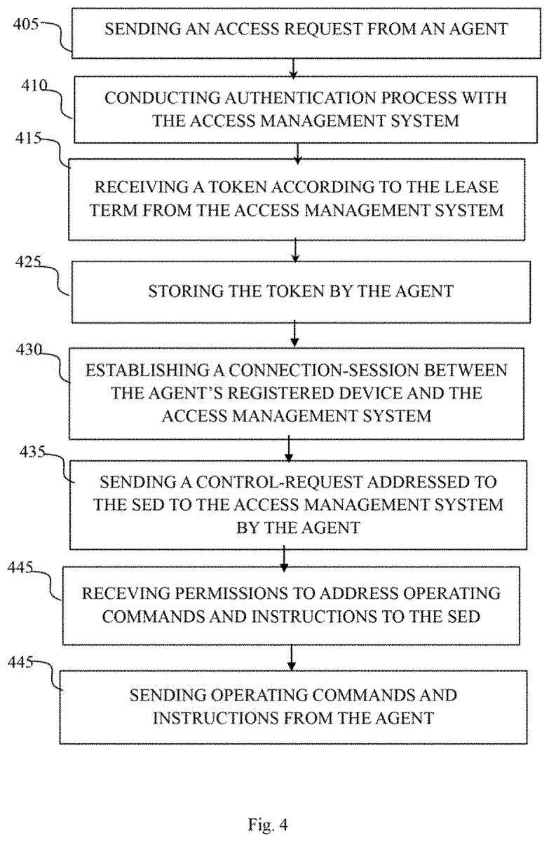

FIG. 4 shows a flowchart illustrating a method for requesting and receiving a control of a SED by an agent, according to exemplary embodiments of the present invention. At step 405 an agent operating an agent's device may send an access-request to an access management system. The access-request may be made by the agent by operating an agent's device configured to send access-requests to an access management system. In some cases, the agent may utilize an application operated on the agent's device. In some cases, the agent may utilize said application to add access information to the access-request. The access information may comprise details such as: an agent identifier a device name, connection details, for example the IP address of the device, and the like. The access information may also comprise the location of the agent's device, the agent's device ID of the agent's device used in the registration process, and the like.

At step 410 the agent may conduct an authentication process with the access management system according to the token information. In some cases, additional information or credentials may be provided by the agent, at the course of the authentication process. For example, in some cases, the agent operating the agent's device may provide the agent's device ID of the agent's device in the authentication process. In some cases, the agent may require providing additional credentials at the course of the authentication process. Such an additional credentials may be a password, one-time-password, digital certificate and the like. In some cases, at the course of the authentication process, the agent may receive a request to the agent to provide a password. The agent may provide the password to the agent's device and then, the agent's device may send the password back to the access management system.

At step 415 the agent may receive to the agent's device a token comprising some information required for establishing the communication-session. The token information can be such as, the agent's device location, the Internet Protocol address (also known as IP address) of the agent's device ID, the lease term, and the like. The token information may also comprise a time stamp indicating the time the token was issued. In some cases, the token information may also have an expiration date. In some cases, the token type may be a token associated with the communication-session. In such cases, the token can be used to present a lease and lease term associated with the communication-session. In some cases, the token type can be a token which presents a lease associated with the token. For example, a lease associated with the token can be utilized by the agent in case the agent disconnects a first communication-session associated with a token, and then reconnects to the access management system. The agent may be able to reconnect to the access management system and utilize the token which has been utilized with the first communication-session, in case the lease term appearing in the token information are still valid.

At step 425 the token may be stored by the agent, at the agent's device. In such cases, the agent's device may connect with a token module which manages the tokens at the access management system and thereby receive the token. At step 430 a communication-session can be established between the agent's device and the access management system. The communication-session may be utilized by the agent's device to convey messages, operation commands, operational instructions, and the like, addressed to the SED. In some cases, the token may be stored by the token manager at the access management system

At step 435 the agent may utilize the agent's device to send a control-request for a SED to the access management system via the newly established communication-session. At step 440 the agent receives permissions to send operating commands and instructions addressed to the SED, to the access management system. In some cases, the agent may receive an indication at the software application operated at the agent's device that said permissions are provided. For example, the agent may utilize a part in a software application operated at the agent's device that allows the agent to send control-requests in case a communication-session is established between the agent's device and the access management system. At step 445 the agent may utilize the agent's device to send operating commands and instructions addressed to the SED, to the access management system. In some cases, the agent may receive the status of the commands and or instructions addressed to the SED, in case the commands and/or the instructions addressed to the SED are executed.

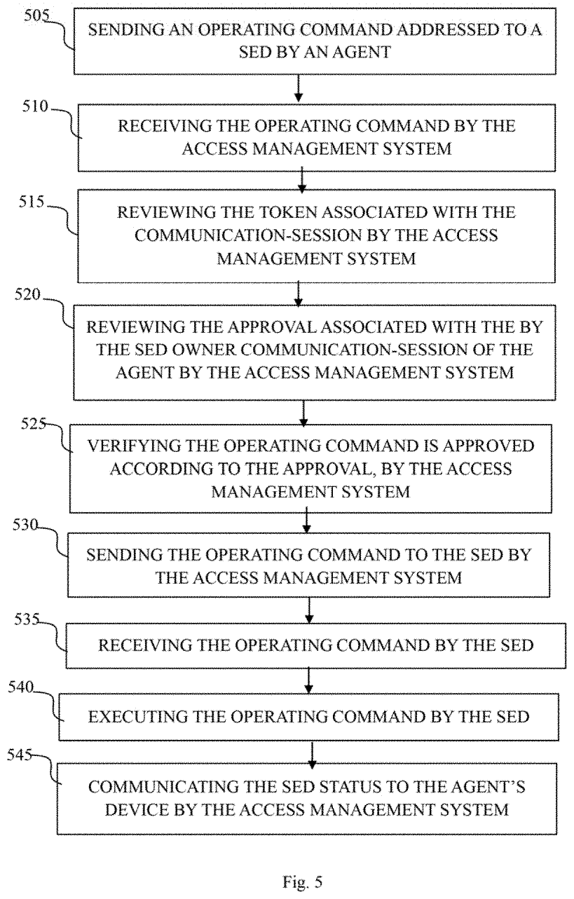

FIG. 5 shows a process of communicating an operating command from an agent to a SED, according to exemplary embodiments of the present invention. At step 505 an agent may send an operating command addressed to a SED, to the access management system. In some cases, said operating command may be the first operating command addressed to a SED after the communication-session has established. At step 510 the access management system receives the operating command. The operating command may be associated with a communication-session identified with an agent ID. In some cases, the access management system may also associate the operating command with an identifier of the communication-session. Thus, the access management system may be configured to generate an ad hoc identifier associated with the communication-session. Such a communication-session identifier held by the access management system can be utilized to associate between the operating command and the communication session. For example, in case the access management system is established between the access management system and an agent's device, the access management system may generate a unique character string, stored in the memory, for identifying the communication-session and associate thereof to the operating command. In some cases, the SED C&C module managed by the access management system may also associate the token and the approval, and the token information to the communication-session identifier.

At step 515 the access management system may review the token associated with the communication session. The token review can be executed on the token stored in the access management system. For example, in cases the token is stored in the token module, the SED C&C module may review the token stored in the token module and verify the information associated with the token, the lease and the lease term defined by the token. In some cases, wherein the token is stored in the agent's device, the access management system may send a request to the agent's device to provide the token, or in some cases, to manifest the token information. In some cases, manifesting the token information may occur via, a secured connection between the agent's device and the access management system. In some cases, such a secure connection may be via a secured connection channel encrypted with an encryption key. The encryption key may be associated with the token, or in some cases, a part of the token information. In some cases, wherein the token be valid as aforementioned, the and the lease term has not expired, the access management system may continue to review the approval associated with the communication-session.

At step 520 the access management system may review the approval associated with the communication-session. In some cases, the approval may be associated with the communication-session identifier controlled and stored by the access management system. The approval review may comprise reviewing the SED ID associated with the approval, review the SED owner ID sent the approval and the like. At step 525 the access management system may verify the command sent from the agent and received by the access management system. The access management system may be able to verify if the command can be approved according to the approval. For example, in case the operating command commands the SED to initiate a digital camera, the access management system may verify that agent is entitled to initiate the digital camera according to the approval.

At step 530 The access management system may send the approved operating command to the SED. Sending the operating command may be according to the SED ID associated with the SED as defined in the approved control-request, associated with the communication-session between the access management system and the agent's device. In some cases, the communication-session between the access management system may be established. In such case, the access management system may convey the approved command to the SED. In some other cases, the access management system may need to establish a communication-session with the SED. Such a communication session may be based on standard communication methods used to communicate with such SED's. At step 435 the SED may receive the operating command. The SED may comprise a computerized device and a connection unit designed to receive such operating commands and execute them. At step 540 the SED may execute the operating command. For example, an unmanned ground vehicle may receive an operating command to drive forward 100 feet. Another operating command may be for a unmanned aerial vehicle may receive a command to fly to a certain location defined by predefined coordinates. Such coordinates can be set by any system, for example indoor positioning system (IPS), designed to consider at least two independent measurable dimensions utilized to define a location. In some cases, upon completion, the SED may communicate back the status of the operating: command. The status may be, command executed, or the new location of the SED with indoor coordinates, and the like.

At step 545 the access management system may indicate the status of the operating commands. In some cases, the SED may report the status to the access management system. In some other cases, the access management system may indicate the location of the SED, and thereby indicate whether the operating command has executed.

Once the access management system indicates the status of the operating command, the status can be sent to the agent via the communication-session maintained between the access management system and the agent's device.

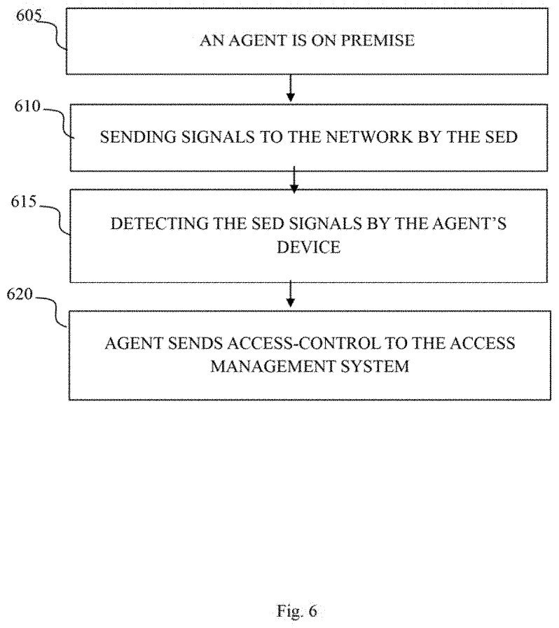

FIG. 6 discloses a method for detecting a SED by an agent via detecting signals sent by the SED, according to exemplary embodiments of the present invention. At step 605 an agent operating an agent's device is on premise. Thus, the agent may be at location wherein the access management is located. In some cases, SED's may also be located at the same location. In that matter, the same location may be any location to which the network protocol utilized to connect and control the SED, can reach. For example, in case the agent can utilize a wireless-based communication to control the SED. In such a case, any SED located in the perimeter of the wireless-based communication (for example, ZigBee, or Wi-Fi) which can communicate over said wireless-based protocol is consider at the same location as the agent.

Step 610 discloses the process of sending signals by the SED. In some cases, the SED's may be configured to send signals over the network. The signals sent by the SED's can be used by other elements in the network to detect the SED's. The elements in the network can be such as, the agents, the SED owners, the access management system, and the like. In some cases, the signals sent by the SED may be over the wireless-based communication and be detectable by the devices in the service-set of the network. The service-set may comprise the other devices utilized the wireless-based communication. For example, the SED may send signals over a wireless connection which can be detected by other members of the service-set. Such signals can be in the format of a beacon frame utilized for detections of wireless devices and wireless access points.

In some embodiments of the present invention, the signals may be detected by the access management system and then transferred to the service-set, or to the elements connecting to the network. In such case, the access management system may control the possibility of the agent's device to detect the SED's. For example, the access management system may detect several SED's. Then, the access management system may communicate a portion of the SED's available for connection, to a portion of agents, identified by the agent ID's.

At step 615 the agent's device operated by the agent may detect the signals sent by the SED, of in some cases the communication sent by the access management system as aforementioned. In some cases, the agent may view the detected SED's available for connection via a software application operated by the agent's device. In some cases, the software application operated by the agent's device may manifest more than one SED available for connection. In such a case, the agent may be provided with the option of choosing at least one SED among the SED's shown by the software application operated by the agent's device.

In some cases, the access management system may communicate the SED available for connection to the agent's device. In some cases, the access management system may comprise some business logics for such a communication with the agent's devices. For example, the access management system may detect the distance of the agent's device from the access management system and communicate the SED available for connection to agent's devices in a distance which is below a certain threshold distance. In some other cases, the business logics may comprise the agent ID, the agent's device ID, the time of the day, and the like. For example, the access management system may communicate the SED available for connection to agent's devices which are in a close distance below the threshold distance to the access management system and with an agent ID which appears in an access list held by the access management system.

At step 620 an agent can send access-request to the access management system. In such a case, the agent may choose the SED among the SED's shown by the software application operated in the agent's device.

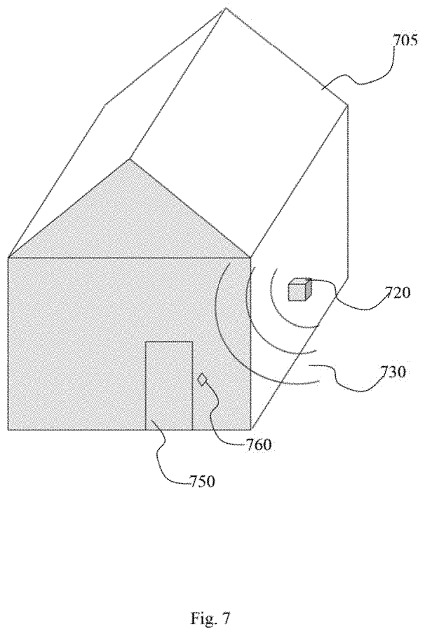

FIG. 7 discloses a configuration of the access management system incorporating an NFC device utilized to identify the SED, according to exemplary embodiments of the present invention. FIG. 7 shows a house 705 comprising a SED 720. The SED 720 can be configured to navigate within the house 705. SED 720 can be configured to communicate via a wireless-based communication. The wireless-based communication can be shown in the wireless coverage 730. For example, the SED 720 may be able to communicate via wireless personal area network such as Bluetooth, Wi-Fi, Zigbee, and the like.

The house also comprises an NFC device 760 located in a close proximity to the door 750. In some cases, the NFC device may be connected to an access management system (not shown) which may be also communicating with the SED 720 as aforementioned. In other some cases, the access management system may be located in the SED 720 as aforementioned In some embodiments of the present invention the access management system may be configured such that, upon detecting the SED 720 by the NFC device 760, the access management system may allow receiving access-requests. For example, an agent (not shown) located near the door, may allow to authenticate with the SED 720, in case the SED 720 is detected by the NFC device 760. In possible embodiments of the present invention, the access management system may be configured such that control-requests may be allowed in case the SED 720 is detected by the NFC device 760. In some other possible embodiments of the present invention, the access management system may be configured such that control requests may be allowed to be sent by the agents, in case the agent and the SED 720 are located in a close proximity to the NFC device 760. In such cases, the agent may be detected by the NFC by the agent's device operated by the agent.

In some cases, upon allowance of the access-request, or control-request the authentication process may take place via alternative connections to the SED. For example, the SED 720 may be detected by the NFC device 760. In such a case, the access management system may allow agents to send access-requests. In some cases, the agent may send the access-request via an alternative communication-session. For example, an agent operating an agent's device is detected by the NFC may utilize an internet connection to send the access-request to the access management system. Hence, the authentication process may also be performed via the internet-based communication-session.

While the disclosure has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method operable by an access management system operated by a computer device, designed to control communications with electronic devices, denoted as SED's, comprising:
receiving by the access management system an access-request from an agent's device operated by an agent, wherein the access-request comprising credentials for an authentication process;
utilizing the credentials from the access-request to authenticate the agent by the access management system;
establishing a communication-session with the agent's device, by the access management system;
generating a token associated with the communication-session, wherein the token defining a communication lease;
sending the token to the agent's device;
receiving by the access management system a control-request from the agent's device operated by the agent, wherein the control-request is received via the communication-session associated with the token, and wherein the control-request comprising:
(i) a SED ID, wherein said SED ID identifies the SED on which the agent requests control,
(ii) an agent ID, wherein the agent ID identifies the agent;
sending said control-request to a SED owner device operated by a SED owner;
receiving an approval from the SED owner, wherein the approval comprises the operating commands and instructions the agent is entitled to execute on the SED, wherein the SED is identified by the SED ID sent in the control-request, and wherein the agent is identified by the agent ID sent in the control-request;
receiving operating commands and instructions addressed to the SED, from the agent operating the agent's device;
communicating the received operating commands and instructions to the SED, wherein the operating commands and instructions communicated to the SED are the operating commands and instructions which the agent is entitled to execute, according to the approval.

2. The method of claim 1, wherein the access-request is received over telecommunications networks.

3. The method of claim 1, wherein the credentials sent with the access-request belong to the agent.

4. The method of claim 1, wherein the credentials sent with the access-request belong to the agent's device.

5. The method of claim 1, wherein the credentials sent with the access-request comprising credentials belonging to the agent and credentials belonging to the agent's device.

6. The method of claim 1, wherein communicating the operating commands and instructions by the access management system to the SED via a software interface.

7. The method of claim 1, wherein the token defines a communication lease defining t lease term wherein the lease term is the time the communication-session can last.

8. The method of claim 1, wherein the token defines a period in which the agent can establish a communication session with the SED, without the need to undergo an authentication process.

9. The method of claim 1, wherein the token defines the network type with which the agent communicates by the access management system.

10. The method of claim 1, wherein the token defines the required physical distance between the agent's device and the SED.

11. The method of claim 1, wherein establishing a communication-session with the agent's device is after agent's device is registered in the access management system.

12. The method of claim 11, wherein the agent's device is registered by an agent's device ID.

13. The method of claim 1, wherein prior receiving by the access management system an access-request from an agent's device, SED's available for connection are detected by the access management system.

14. The method of claim 13, wherein the detected SED available for connection to the agent's devices.

15. The method of claim 13, wherein the detection of the SED is via wireless-based communication.

16. An access management system operable on at least one computerized device comprising a processing unit, a memory unit and a communication unit, designed to communicate with SED's, comprising:
a token module designed to instruct the computerized device to receive access-request from an agent's device operated by an agent, wherein the token module is also designed to instruct the computerized device to:
(i) utilize credentials existing in the access-request for conducting an authentication process for an agent operated an agent device,
(ii) maintain communication-sessions with said computerized device operated by an agent,
(iii) generate tokens associated with the communication-session, wherein the token defining a communication lease;
(i) send tokens to the agent's device
a SED C&C module designed to instruct the computerized device to receive from the token module a token associated with a communication-session and an access-request from an agent's device operated by an agent, wherein the SED C&C module is also designed to instruct the computerized device to:
(i) receive control-requests from an agent, wherein a control request comprises an agent ID identifying the agent and a SED ID identifying the SED,
(ii) send said control-requests to SED owner devices operated by SED owner,
(iii) receive an approval from the SED owner, wherein the approval comprises the operating commands and instructions the agent is entitled to execute on the SED,
(iv) receive operating commands and instructions addressed to the SED, from the agent operating the agent's device,
(v) communicate the received operating commands and instructions to the SED, wherein the operating commands and instructions communicated to the SED are the operating commands and instructions which the agent is entitled to execute, according to the approval.

17. The access management system of claim 16, wherein the access management system is operable on the SED.

18. The access management system of claim 16, wherein the SED C&C module communicates in two communication-sessions.

19. The access management system of claim 16, wherein the detection of the SED is via wireless-based communication.

20. The access management system of claim 16 is further configured to connect to an NFC utilized to detect the SED.
